(19) United States
(12) Patent Application Publication
(10) Pub. No.: US 2008/0137741 A1
(43) Pub. Date: Jun. 12, 2008

(54) Video transcoding

(76) Inventor: Hari Kalva, Delray Beach, FL (US)

Correspondence Address: MARTIN NOVACK, 16355 VINTAGE OAKS LANE, DELRAY BEACH, FL, 33484, US

(21) Appl. No.: 11/999,501

(22) Filed: Dec. 5, 2007

Related U.S. Application Data
(60) Provisional application No. 60/873,010, filed on Dec. 5, 2006.

(51) Int. Cl. H04N 7/26

(52) U.S. Cl. 375/240.12; 375/240.25; 375/E07.026

(57) ABSTRACT

A method for receiving encoded H.264 video signals and transcoding the received encoded signals to encoded MPEG-2 video signals, including the following steps: decoding the encoded H.264 video signals to obtain uncompressed video signals and to also obtain H.264 feature signals; deriving MPEG-2 feature signals from the H.264 feature signals; and producing the encoded MPEG-2 video signals using the uncompressed video signals and the MPEG-2 feature signals. The H.264 feature signals include H.264 macro block modes and include H.264 motion vectors.

### RELATED APPLICATION

Priority is claimed from U.S. Provisional Patent Application No. 60/873,010, filed Dec. 5, 2006, and said U.S. Provisional Patent Application is incorporated by reference.

### FIELD OF THE INVENTION

This invention relates to compression of video signals, and to transcoding between video standards having different specifications. The invention also relates to transcoding from H.264 compressed video to MPEG-2 compressed video.

### BACKGROUND OF THE INVENTION

MPEG-2 is a coding standard of the Motion Picture Experts Group of ISO that was developed during the 1990's to provide compression support for TV quality transmission of digital video. The standard was designed to efficiently support both interlaced and progressive video coding and produce high quality standard definition video at about 4 Mbps. The MPEG-2 video standard uses a block-based hybrid transform coding algorithm that employs transform coding of motion-compensated prediction error. While motion compensation exploits temporal redundancies in the video, the DCT transform exploits the spatial redundancies. The asymmetric encoder-decoder complexity allows for a simpler decoder while maintaining high quality and efficiency through a more complex encoder. Reference can be made, for example, to ISO/IEC JTC11/SC29/wVG11, “Information technology—Generic Coding of Moving Pictures and Associated Audio Information Video”, ISO/IEC 13818-2:2000, incorporated by reference.

The H.264 video coding standard (also known as Advanced Video Coding or AVC) was developed, more recently, through the work of the International Telecommunication Union (ITU) video coding experts group and MPEG (see ISO/IEC JTC11/SC29/wG11, “Information Technology—Coding of Audio-Visual Objects—Part 10; Advanced Video Coding”, ISO/IEC 14496-10:2005., incorporated by reference). A goal of the H.264 project was to create a standard capable of providing good video quality at substantially lower bit rates than previous standards (e.g. half or less the bit rate of MPEG-2, H.263, or MPEG-4 Part 2), without increasing the complexity of design so much that it would be impractical or excessively expensive to implement. An additional goal was to provide enough flexibility to allow the standard to be applied to a wide variety of applications on a wide variety of networks and systems. The H.264 standard is flexible and offers a number of tools to support a range of applications with very low as well as very high bitrate requirements. Compared with MPEG-2 video, the H.264 video format achieves perceptually equivalent video at ⅓ to ½ of the MPEG-2 bitrates. The bitrate gains are not a result of any single feature but a combination of a number of encoding tools. However, these gains come with a significant increase in encoding and decoding complexity.

Notwithstanding the increased complexity of H-264, its dramatic bandwidth saving provides a high incentive for TV broadcasters to adopt H.264, for reasons including the potential use of the bandwidth savings to provide additional channels and/or new or expanded data and interactive services. Also, with the coding gains of H.264, full length HDTV resolution movies can now be stored on DVDs. Furthermore, the fact that the same video coding format can be used for broadcast TV as well as Internet streaming will create new service possibilities and speeds up the adoption of H.264 video, which is already in progress.

As described in my publication “Issues In H.264/MPEG-2 Transcoding”, IEEE Consumer Communications And Networking Conference, pp. 657-659, January, 2004, there is an important need for transcoding technology that can transcode H.264 to MPEG-2, with reduced complexity by making use of information obtained in the H.264 video decoding process. It is among the objects of the present invention to achieve efficiencies in the H.264 to MPEG-2 (as well as to MPEG-4, Part 2) transcoding process that render the widespread use of H.264 coding more practical while MPEG-2 types of digital video systems remain commonplace. It is also among the objects hereof to improve video transcoding between standards having different compression capabilities.

### SUMMARY OF THE INVENTION

The present invention uses certain information obtained during the decoding of a first compressed video standard (e.g. H.264) to derive feature signals (e.g. MPEG-2 feature signals) that facilitate subsequent encoding, with reduced complexity, of the uncompressed video signals into a second compressed video standard (e.g. encoded MPEG-2 video).

A preferred embodiment of the invention involves transcoding from H.264 to MPEG-2, but the invention can also have application to other transcoding; for example, from H.264 to MPEG-4 (Part 2), or from a first relatively higher compression standard to a second relatively lower compression standard.

In accordance with a form of the invention, a method is set forth for receiving first video signals encoded with a first relatively higher compression standard and transcoding the first video signals to second video signals encoded with a second relatively lower compression standard, including the following steps: decoding the encoded first video signals to obtain uncompressed first video signals and to also obtain first feature signals of said encoded first video signals; deriving second feature signals from said first feature signals; and producing said encoded second video signals using said uncompressed first video signals and said second feature signals.

In accordance with a preferred form of the invention, a method is set forth for receiving encoded H.264 video signals and transcoding the received encoded signals to encoded MPEG-2 video signals, including the following steps: decoding the encoded H.264 video signals to obtain uncompressed video signals and to also obtain H.264 feature signals; deriving MPEG-2 feature signals from said H.264 feature signals; and producing said encoded MPEG-2 video signals using said uncompressed video signals and said MPEG-2 feature signals.

In a preferred embodiment of this form of the invention, the H.264 feature signals include H.264 macro block modes and include H.264 motion vectors. In this embodiment, the derived MPEG-2 feature signals include MPEG-2 macro block modes mapped from the H.264 macro block modes. Also in this embodiment the mode mapping includes selection of MPEG-2 macro blocks based on prediction error analysis. The derived MPEG-2 feature signals also include MPEG-2 motion vector seeds derived from the H.264 motion vectors, motion vector search ranges derived from the H.264 motion vectors, and vector search windows derived from the H.264 motion vectors. The decoding, deriving, and producing steps are performed using a processor, for example a computer processor.

Further features and advantages of the invention will become more readily apparent from the following detailed description when taken in conjunction with the accompanying drawings.

### BRIEF DESCRIPTION OF THE DRAWINGS

FIG. 1 is a block diagram of an example of the type of systems that can be used in conjunction with the invention.

FIG. 2 shows an example of another type of system that can be used in conjunction with the invention, wherein digital video encoded in H.264 is the output of a DVD player.

FIG. 3 shows a conventional transcoding approach wherein a conventional H.264 decoder, which receives H.264 compressed video and produces uncompressed video which is, in turn, encoded by a conventional MPEG-2 encoder.

FIG. 4 illustrates an approach of transcoding in accordance with an embodiment of the invention.

FIGS. 5 and 6 show, respectively, operation of a simplified conventional MPEG-2 encoder, and of a reduced complexity MPEG-2 encoder that is part of an embodiment of the invention.

FIG. 7 is a table that shows the mode mapping for an embodiment of the invention.

FIG. 8 illustrates operation of a feature used in an embodiment of the invention, and shows a motion vector MV with X and Y components MVx and MVy.

FIG. 9 illustrates operation of a feature used in an embodiment of the invention, and shows a motion vector MV of the incoming H.264 and the MPEG-2 motion estimation that is performed in a small area around the incoming MV defined by the search window size W_{R}.

FIG. 10 shows a table that relates the MPEG-2 motion vector search window to the number of motion vectors in a H.264 macro block.

FIG. 11 is a flow diagram of a process in accordance with an embodiment of the invention.

### DETAILED DESCRIPTION

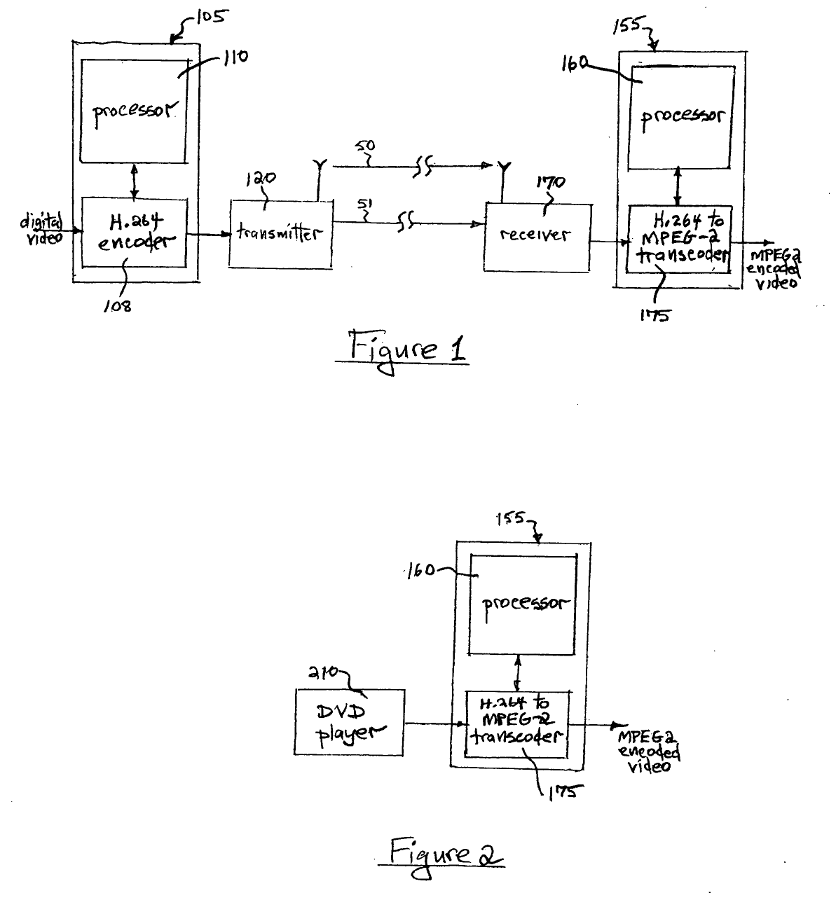

FIG. 1 is a block diagram of an example of the type of systems that can be advantageously used in conjunction with the invention. Two processor-based subsystems 105 and 155 are shown as being in communication over a channel or network, which may include, for example, any wired or wireless communication channel such as a broadcast channel 50 and/or an internet communication channel or network 51. The subsystem 105 includes processor 110 and the subsystem 155 includes processor 160. When programmed in the manner to be described, the processor subsystems 105 and 155 and their associated circuits can be used to implement embodiments of the invention. The processors 110 and 160 may each be any suitable processor, for example an electronic digital processor or microprocessor. It will be understood that any programmed general purpose processor or special purpose processor, or other machine or circuitry that can perform the functions described herein, can be utilized. The subsystems 105 and 155 will typically include memories, clock, and timing functions, input/output functions, etc., all not separately shown, and all of which can be of conventional types.

In the example of FIG. 1, the subsystem 105 can be part of a television broadcast station which receives and/or produces input digital video (arrow 111) and compresses the digital video, using an H.264 encoder 108. The encoded digital signal is coupled to transmitter module 120. At the receiver end, a receiver module 170 receives the broadcast H.264 encoded video, which is transcoded (block 175) to MPEG-2 format using the principles of the invention to produce MPEG-2 encoded digital video. In the example of FIG. 1, the now MPEG-2 encoded signals are conventionally decoded to produce output digital video signals that can be, for example, displayed and/or recorded and/or used in any suitable way. The transcoder 175, to be described, can be implemented in hardware, firmware, software, combinations thereof, or by any suitable means, consistent with the principles hereof. In a similar vein, the block 175 can, for example, stand alone (e.g. in a set-top box), or be incorporated into the processor 160, or implemented in any suitable fashion consistent with the principles hereof.

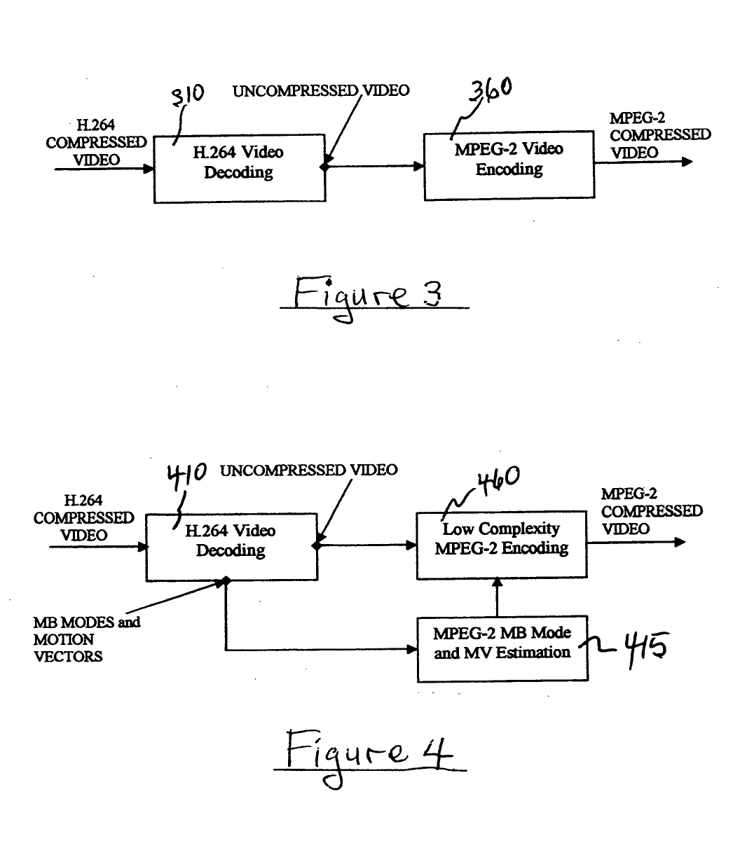

FIG. 2 shows another illustrative example, wherein digital video encoded in H.264 is the output of a DVD player 210. Processor 160, processor subsystem 155, and transcoder 175, are similar to their counterparts, of like reference numerals, in FIG. 1.

FIG. 3 shows a conventional transcoding approach that comprises a conventional H.264 decoder 310, which receives H.264 compressed video and produces uncompressed video which is, in turn, encoded by a conventional MPEG-2 encoder 360.

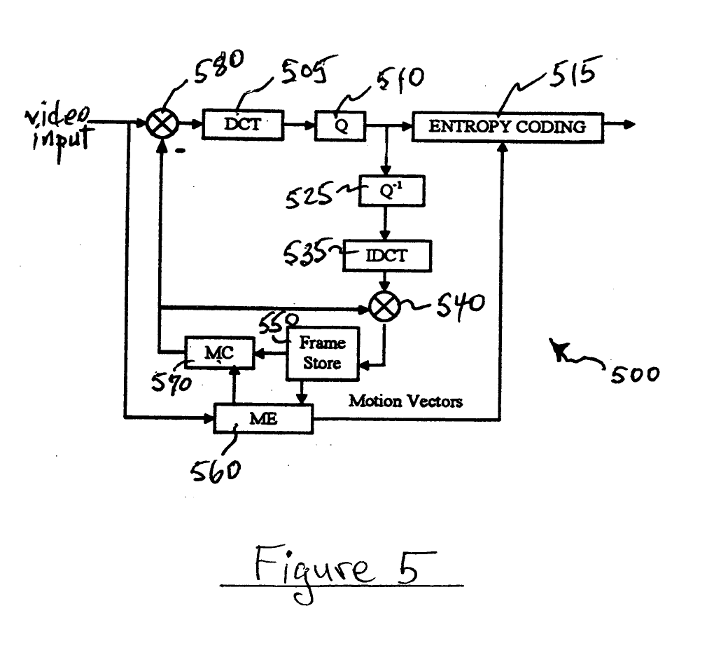

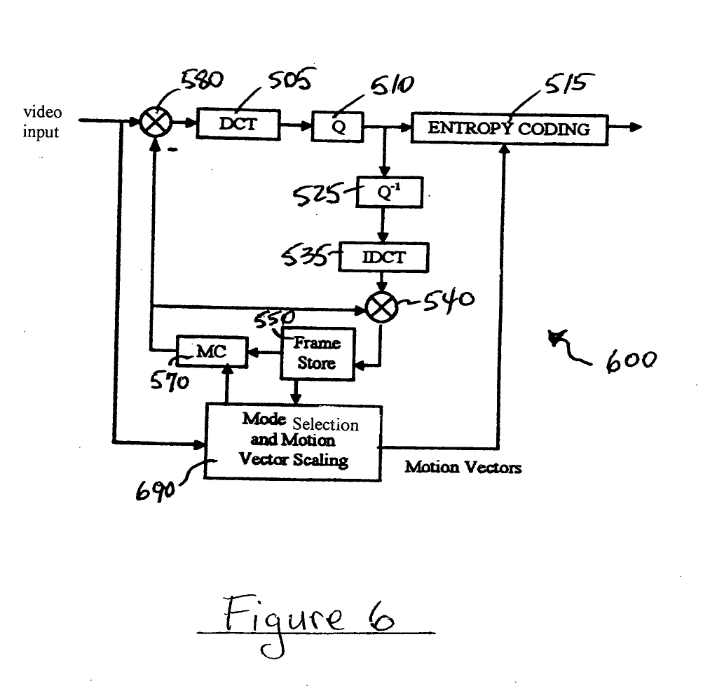

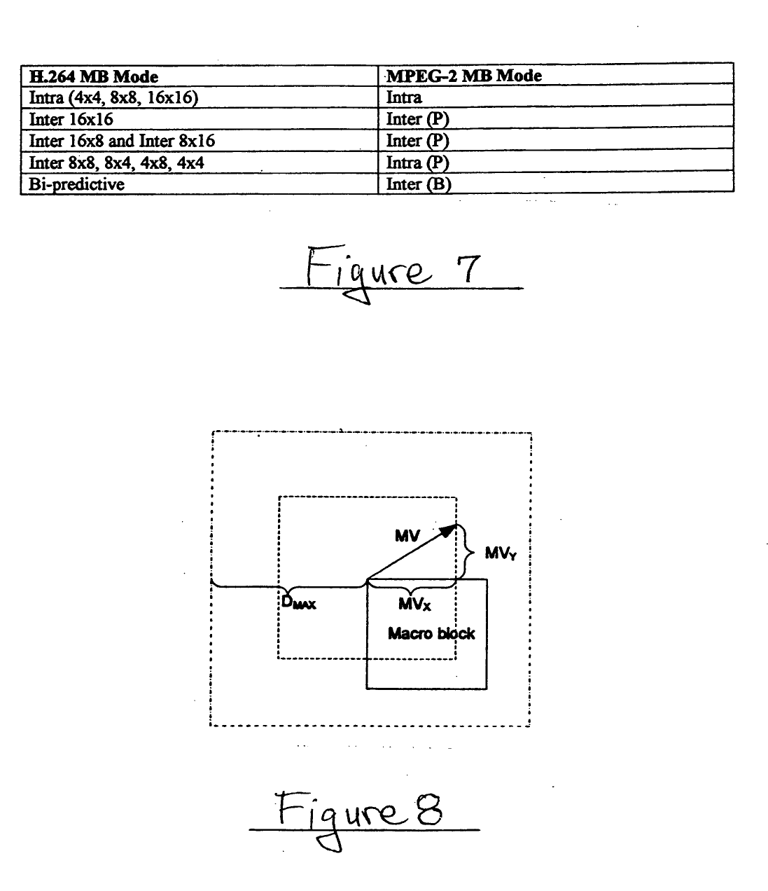

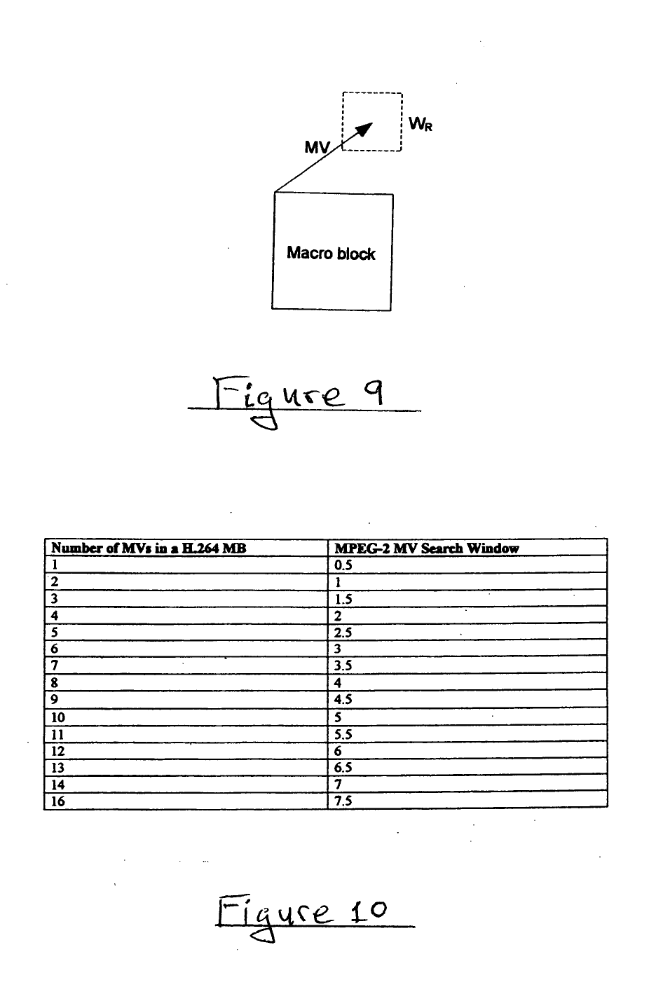

FIG. 4 illustrates the approach of an embodiment of the invention. In FIG. 4, an H.264 decoder 410 is used to obtain uncompressed video. In this case, however, information gathered in the H.264 decoding stage will be used to reduce the complexity of operation of the MPEG-2 encoder 460. In the FIG. 4 embodiment, H-264 macro block modes and motion vector information is input to the block 415, which represents the computation, based on such inputs, of estimates of MPEG-2 macro block mode(s) and motion vector(s) estimation. The uncompressed video, and the computed feature signals, are then used by the low complexity MPEG-2 encoder 460 to produce the MPEG-2 compressed video.

FIGS. 5 and 6 show, respectively, a simplified conventional MPEG-2 encoder 500, and a reduced complexity MPEG-2 encoder 600 that is part of an embodiment of the invention. Like reference numerals in the two diagrams refer to corresponding or similar elements or steps. The input video is shown as an input to a difference function 580, the output of which is then discrete cosine transformed (block 505) and quantized (block 510). The result is one input to entropy coding function 515 and also inverse quantized (block 525) and then inverse DCTed (block 535). The result is one input to adder function 540, the output of which is stored by frame store 550, the stored frame information being received by motion compensation function 570, the result of which is an input to difference function 580 and adder 540.

In the conventional MPEG-2 encoder, the stored frame information is also received by motion estimation function (block 560), which also receives the input video, and the motion estimation output, namely the motion vector information, is a further input to motion compensation function 570 and to the entropy coding function 515.

In the reduced complexity MPEG-2 encoder of FIG. 6, the frame store information is received by a mode selection and motion vector scaling function block 690, an output of which is a further input to motion compensation function 570 and to the entropy coding function 515. The complexity of MPEG-2 encoding is reduced by eliminating the motion estimation stage which is computationally expensive. The motion estimation process is used to determine the best coding mode for a macro block (MB). In the reduced complexity MPEG-2 encoder, the MB mode is determined based on the H.264 MB modes and the MPEG-2 motion vectors are derived from H.264 motion vectors. The reduced complexity MPEG-2 encoder thus substantially reduces the motion estimation and MB mode selection complexity.

In accordance with a feature of embodiments of the invention, reduction in complexity of the MPEG-2 encoding is achieved using aspects of the H.264 decoding that reveal useful information. Both H.264 and MPEG-2 encode video frames using a block-based video coding approach. The algorithms use 16×16 blocks of video called macro blocks (MB). The MBs are encoded one at a time, typically in a raster scan order. Each encoded MB has a coding mode, called MB mode, associated with it. The MB mode indicates whether a MB is coded as Intra (without temporal prediction) or Inter (with temporal prediction). The coding mode from H.264 can be used to determine the coding mode in MPEG-2. Since H.264 supports more encoding modes than MPEG-2, mode mapping has to carefully consider the coding modes for mapping. An MPEG-2 mode can be Inter or Intra, whereas H.264 modes can also specify smaller block sizes. If the incoming H.264 video MB is encoded as Intra, MPEG-2 MB is coded as Intra. If the incoming H.264 video MB is encoded as Inter 16×16, MPEG-2 MB is coded as Inter. There is also a “bi-predictive” mode (“B”) that utilizes more than one prior frame for temporal prediction. FIG. 7 is a table that shows the mode mapping for an embodiment of the invention.

In accordance with another feature of embodiments of the invention, the prediction error of the macroblocks (MBs) (that is, the difference between the actual and prediction) is analyzed to determine the MPEG-2 coding modes. The residual of the MB is characterized using its mean and variance. One or more thresholds of the prediction error, for example mean and variance thresholds, are determined using, for example, a training data set of MBs. The thresholds can then be used to classify a MB of the MPEG-2 encoded signal as being Inter or Intra.

As was noted above, H.264 supports multiple reference frames. MPEG-2 on the other hand uses one previous picture for Inter P MB and two pictures for Inter B MB. The mode mapping has to take this into account. Mode mapping when the reference picture is not the previous picture is also shown in the table of FIG. 7.

MPEG-2 supports encoding of frames as a frame picture or field picture. In H.264, the frame vs. field decision is made at a MB level. Motion estimation (ME) is the most computationally intensive component of the MPEG-2 encoding process. The motion estimation process finds a best match (prediction) for the MB being coded. The motion estimation complexity can be substantially reduced by dynamically adjusting the search range. The search range can be determined based on the motion vector (MV) from the H.264 decoding stage. If the H.264 MB is inter 16×16, the motion vector can be directly used with refinement in a half-pixel or one-pixel window. The motion vectors outside the frame boundary are treated as special cases and truncated to the frame boundary.

If the H.264 MB is coded as two inter 16×8 or 8×16 partitions, a single MV is determined as a function of the MVs of the partitions:

MPEG2MV=f(MV8×16);

MPEG2MV=f(MV16×8).

A simple average of the motion vectors is one way computing the MPEG-2 MV. If the reference frame is more than 1 frame away, the MV search range/window is increased. Alternatively, a measure of the distance, such as average motion, can be used to scale the motion vector. For example, if the measure of the distance is 4 pixels per frame, the target motion vector is adjusted by that distance and the search range increased appropriately.

The motion vectors in MPEG-2 are determined by searching for the best block match in the previous frame. Encoders are given a search range to find the best match. The search range determines the complexity of the motion estimation process. The larger the search range, the more complex the motion estimation process. Instead of using a fixed search range, a dynamic search range, based on information from the H.264 signals, can be used to reduce the motion estimation complexity. The MPEG-2 seed motion vector derived from the incoming H.264 motion vectors can be used to determine the search range. A macro block in H.264 can have up to 16 motion vectors (MVs). One way of determining the search range is using the absolute value of the H.264 MVs. The following is an example of a relationship that can be used:

MPEG-2 MVRange=Max(ABS(mvx),ABS(mvy));

where ABS is absolute value, mvx is the x component (horizontal) of the motion vector, and mvy is the y component of the motion vector.

FIG. 8 shows a motion vector MV with the X and Y components MVx and MVy. The default search range for the MPEG-2 encoder is given by D_{MAX}. The large search area results in a larger number of search points and hence higher complexity. The search range can be adjusted for each macro block based on the MV of the MB in H.264. The Figure shows a MB with motion vector MV. The search range can be set to max of MVx and MVy, and in this case will be set to MVx. The MPEG-2 motion estimation process uses this search range instead of the default D_{MAX} and thus reduces the motion estimation complexity.

In accordance with a further feature of an embodiment of the invention, a seed motion vector can be used to reduce the motion estimation complexity even further. Instead of using a search range as determined by the incoming motion vector, a smaller search window is determined. FIG. 9 shows a motion vector MV of the incoming H.264 and the MPEG-2 motion estimation is performed in a small area around the incoming MV defined by the search window size W_{R}. The search window of W_{R} gives lower complexity but will reduce the motion compensation efficiency if the best match is not found and thus reduces the quality of the encoded video. The search window can be as small as half a pixel. Since the incoming H.264 MBs can have multiple motion vectors, the seed motion vector and search area of MPEG-2 are determined based on all the available MVs. Averaging the MVs of a H.264 MB can be a good seed, but as the number of MVs increases, the accuracy of the seed MV is likely to drop. The reduced accuracy of the MPEG-2 seed MV can be addressed by increasing the size of the search window.

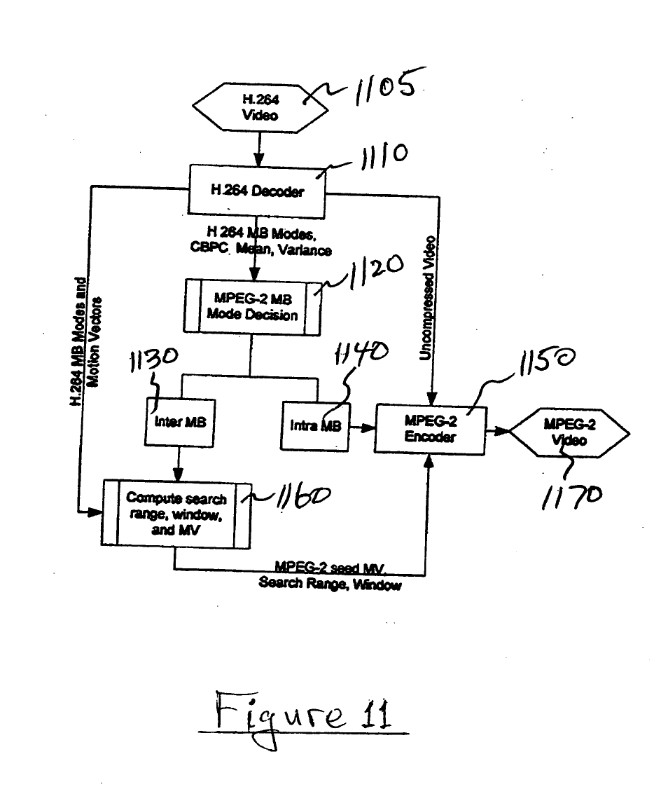

With an increased search window, a larger number of search points are evaluated thus increasing the chances of finding a better MV. FIG. 10 shows a table that relates the MPEG-2 motion vector search window to the number of motion vectors in a H.264 macro block.

Another approach for determining search window size that can be used in an embodiment of the invention is:

SearchWindow log₂(number of MVs);

The length of the incoming vectors is also used to determine the search window. Shorter motion vectors indicate smaller motion and hence the search window can be reduced.

$$\begin{matrix}SearchWindow = f ( MV ) ; \\ = {log}_{2} ( Max ( ABS ( mvx ) , ABS ( mvy ) ) ) .\end{matrix}$$

It will be understood that other ways of using the length of the MV to determine the search window can be developed.

All the foregoing methods for reducing the motion estimation complexity can be combined to reduce the complexity without affecting the quality substantially. The dynamic range, the dynamic window based on the number of MVs, and the window based on the length of the MVs can be combined to reduce the overall complexity. The intersection of the search areas determined by the three approaches can be used to determine the reduced search area for motion estimation.

An adaptive approach can select Dynamic Range or Dynamic Window based on the MB mode information. For example, if the number of H.264 motion vectors are 1 or 2, a dynamic window can be used. If the number of motion vector is greater than 2, a dynamic range is likely to work better as the seed motion vector for MPEG-2 in these cases may not point in the direction of the actual MPEG-2 MV. A dominant direction and a more accurate seed MV can be computed based on the MVs of the current and neighboring MBs.

FIG. 11 is a flow diagram of a process in accordance with an embodiment of the invention. The input H.264 video is represented at 1105 and the transcoded MPEG-2 video is represented at 1170. The block 1110 represents the H.264 decoding, and the block 1120 represents implementing the MPEG-2 macro block mode decision. The blocks 1130 and 1140 respectfully represent selection of the Inter or Intra macro blocks, and the block 1160 represents the computation of search range, window and motion vector, using the input features from the h.264 decoding operation. The block 1150 represents the lower complexity MPEG-2 encoder, which receives the macro block and motion vector seed, search range, and search window information.

The invention has been described with reference to particular preferred embodiments, but variations within the spirit and scope of the invention will occur to those skilled in the art. For example, it will be understood that other suitable configurations that implement the described techniques can be utilized.

1. A method for receiving encoded H.264 video signals and transcoding the received encoded signals to encoded MPEG-2 video signals, comprising the steps of:
decoding the encoded H.264 video signals to obtain uncompressed video signals and to also obtain H.264 feature signals;
deriving MPEG-2 feature signals from said H.264 feature signals; and
producing said encoded MPEG-2 video signals using said uncompressed video signals and said MPEG-2 feature signals.

2. The method as defined by claim 1, wherein said H.264 feature signals include H.264 macro block modes.

3. The method as defined by claim 1, wherein said H.264 feature signals include H.264 motion vectors.

4. The method as defined by claim 2, wherein said H.264 feature signals include H.264 motion vectors.

5. The method as defined by claim 2, wherein said derived MPEG-2 feature signals include MPEG-2 macro block modes mapped from said H.264 macro block modes.

6. The method as defined by claim 5, wherein said mode mapping includes selection of MPEG-2 macro blocks based on prediction error analysis.

7. The method as defined by claim 6, wherein said prediction analysis comprises determining the mean and variance of prediction error.

8. The method as defined by claim 3, wherein said derived MPEG-2 feature signals include MPEG-2 motion vector seeds derived from said H.264 motion vectors.

9. The method as defined by claim 3, wherein said derived MPEG-2 feature signals include MPEG-2 motion vector search ranges derived from said H.264 motion vectors.

10. The method as defined by claim 3, wherein said derived MPEG-2 feature signals include MPEG-2 motion vector search windows derived from said H.264 motion vectors.

11. The method as defined by claim 1, wherein said decoding, deriving, and producing steps are performed using a processor.

12. A method for receiving first video signals encoded with a first relatively higher compression standard and transcoding the first video signals to second video signals encoded with a second relatively lower compression standard, comprising the steps of:
decoding the encoded first video signals to obtain uncompressed first video signals and to also obtain first feature signals of said encoded first video signals;
deriving second feature signals from said first feature signals; and
producing said encoded second video signals using said uncompressed first video signals and said second feature signals.

13. The method as defined by claim 12, wherein said first feature signals include first macro block modes.

14. The method as defined by claim 12, wherein said first feature signals include first motion vectors.

15. The method as defined by claim 13, wherein said first feature signals include first motion vectors.

16. The method as defined by claim 13, wherein said derived second feature signals include second macro block modes mapped from said second macro block modes.

17. The method as defined by claim 16, wherein said mode mapping includes selection of second macro blocks based on prediction error analysis.

18. The method as defined by claim 17, wherein said prediction analysis comprises determining the mean and variance of prediction error.

19. The method as defined by claim 14, wherein said derived second feature signals include second motion vector seeds derived from said first motion vectors.

20. The method as defined by claim 14, wherein said derived second feature signals include second motion vector search ranges derived from said first motion vectors.

21. The method as defined by claim 14 wherein said derived second feature signals include second motion vector search windows derived from said first motion vectors.

22. The method as defined by claim 12, wherein said decoding, deriving, and producing steps are performed using a processor.
